(19) United States
(12) Patent Application Publication
(10) Pub. No.: US 2026/0212169 A1
(43) Pub. Date: Jul. 23, 2026

(54) IMAGING DEVICE, CONTROL DEVICE, AND SPIKING NEURAL NETWORK

(71) Applicant: SONY SEMICONDUCTOR SOLUTIONS CORPORATION, KANAGAWA (JP)

(72) Inventors: TAKESHI OYAKAWA, KANAGAWA (JP); SUSUMU HOGYOKU, KANAGAWA (JP)

(21) Appl. No.: 19/139,868

(22) PCT Filed: Nov. 6, 2023
(86) PCT No.: PCT/JP2023/039850

§ 371 Date: Jun. 16, 2025

(30) Foreign Application Priority Data
Dec. 23, 2022 (JP) 2022-206203

(51) Int. Cl. G06N 3/049; G06N 3/067

(52) U.S. Cl. CPC G06N 3/049; G06N 3/0675

(57) ABSTRACT

Saturation of an event output is suppressed while a decrease in sensitivity is suppressed. An imaging device includes: a light receiving section that is provided in pixels arranged in a matrix in a row direction and a column direction and outputs a pulse on the basis of incidence of photons; a counter that is provided in the pixels and counts the pulse output from the light receiving section; and a comparator that is provided in the pixels and outputs an event on the basis of a comparison result between a count value by the counter and a counter threshold. The comparator may output the event when the count value exceeds the counter threshold. The comparator may reset the counter when the count value exceeds the counter threshold.

### TECHNICAL FIELD

The present technology relates to an imaging device, a control device, and a learning model. Specifically, the present technology relates to an imaging device, a control device, and a spiking neural network capable of controlling a generation rate of an event.

### BACKGROUND ART

In an imaging device, there is a technology of generating an event according to an amount of light incident on each pixel. At this time, with a high light amount, an event output may be saturated because firing occurs frequently. In order to suppress a firing rate, for example, a technique in which a driving method for shortening an exposure time is introduced has been proposed (See, for example, Non-Patent Document 1.).

### CITATION LIST

### Non-Patent Document

Non-Patent Document 1: Ecole polytechnique fédérale de Lausanne (EPFL), Canon Inc., “Megapixel time-gated SPAD image sensor for 2D and 3D imaging applications”, 2020

### SUMMARY OF THE INVENTION

### Problems to be Solved by the Invention

However, in the above-described conventional technology, if the exposure time is shortened in order to suppress the saturation of the event output, there is a possibility that the sensitivity decreases and noise increases.

The present technology has been made in view of such a situation, and an object thereof is to suppress saturation of an event output while suppressing a decrease in sensitivity.

### Solutions to Problems

The present technology has been made to solve the above-described problems, and a first aspect thereof is an imaging device including: a light receiving section that is provided in pixels arranged in a matrix in a row direction and a column direction and outputs a pulse on the basis of incidence of photons; a counter that is provided in the pixels and counts the pulse output from the light receiving section; and a comparator that is provided in the pixels and outputs an event on the basis of a comparison result between a count value by the counter and a counter threshold. This brings about an effect that an event in which an output rate of the pulse is compressed is output.

Furthermore, in the first aspect, the comparator may output the event when the count value exceeds the counter threshold. This brings about an effect that the output rate of the pulse is compressed on the basis of the counter threshold.

Furthermore, in the first aspect, the comparator may reset the counter when the count value exceeds the counter threshold. This brings about an effect that counting is started from the beginning each time the event is output.

Furthermore, in the first aspect, the counter and the comparator may be disposed below the light receiving section. This brings about an effect that the counter and the comparator are formed for each light receiving section while suppressing an increase in a plane size of the imaging device.

Furthermore, in the first aspect, the light receiving section may include a single photon avalanche diode (SPAD). This brings about an effect that photons are counted one by one.

Furthermore, in the first aspect, a control section that controls the counter threshold on the basis of an output rate of the event may be included. This brings about an effect that the counter threshold is dynamically changed according to an amount of light.

Furthermore, in the first aspect, the control section may include a spiking neural network that controls the counter threshold on the basis of an input of the event. This brings about an effect that the counter threshold can be controlled asynchronously.

Furthermore, in the first aspect, the spiking neural network may include: a plurality of first spiking neurons, each receiving an input of the event and firing on the basis of an input rate of the event; and a second spiking neuron to which firing of the plurality of first spiking neurons is respectively input and that fires on the basis of an input rate of firing of the first spiking neurons. This brings about an effect that the input rate in a spatial direction of the event and the input rate in a time direction of the event can be detected.

Furthermore, in the first aspect, the spiking neural network may be capable of detecting an input rate in a spatial direction of the event and an input rate in a time direction of the event. This brings about an effect that an event rate can be controlled asynchronously while stabilizing the counter threshold with respect to a temporal change and a spatial change of the light amount.

Furthermore, in the first aspect, each of the first spiking neurons may include: a high-rate detection first spiking neuron that fires on the basis of an increase in an input rate of the event; and a low-rate detection first spiking neuron that fires on the basis of a decrease in an input rate of the event, and the second spiking neuron may include: a high-rate detection second spiking neuron connected such that a neuron membrane potential rises on the basis of an input of firing from the high-rate detection first spiking neuron and a neuron membrane potential falls on the basis of an input of firing from the low-rate detection first spiking neuron; and a low-rate detection second spiking neuron connected such that a neuron membrane potential falls on the basis of an input of firing from the high-rate detection first spiking neuron and a neuron membrane potential rises on the basis of an input of firing from the low-rate detection first spiking neuron. This brings about an effect that the counter threshold is updated so as to be up/down according to the low light amount and the high light amount while enabling detection of the event rate asynchronously.

Furthermore, in the first aspect, the spiking neural network may be capable of controlling the counter threshold over a plurality of stages. This brings about an effect that the counter threshold is finely adjusted according to the amount of light.

Furthermore, in the first aspect, the spiking neural network may be capable of controlling the counter threshold at a constant rate. This brings about an effect that the counter threshold is finely adjusted according to the amount of light.

Furthermore, in the first aspect, the control section may control a negative power supply voltage of the light receiving section on the basis of an output rate of the event. This brings about an effect that the sensitivity of the light receiving section is adjusted according to the amount of light received by the light receiving section.

Furthermore, in the first aspect, a vertical arbiter that arbitrates an output of the event in a row on the basis of a detection result of the event for each row may be further included. This brings about an effect that the event is output only from the row in which the event has occurred.

Furthermore, in the first aspect, a horizontal arbiter that arbitrates an output of the event in a column on the basis of a detection result of the event for each column may be further included. This brings about an effect that the event is output only from the column in which the event has occurred.

Furthermore, a second aspect is a control device including a control section that receives, as an input of an event, a comparison result between a count value of a pulse output on the basis of incidence of a photon and a counter threshold, and controls the counter threshold on the basis of an output rate of the event. This brings about an effect that the event in which an output rate of the pulse is compressed is output while changing a compression rate according to an amount of light.

Furthermore, in the second aspect, the control section may include a spiking neural network that controls the counter threshold on the basis of the input of the event. This brings about an effect that the counter threshold can be controlled asynchronously.

Furthermore, a third aspect is a spiking neural network including: a plurality of first spiking neurons, each receiving an input of a pulse generated on the basis of incidence of photons at spatial positions different from each other, and firing on the basis of an input rate of the pulse; and a second spiking neuron to which firing of the plurality of first spiking neurons is respectively input and that fires on the basis of an input rate of firing of the first spiking neurons. This brings about an effect that an input rate in a spatial direction of an event and an input rate in a time direction of the event can be detected asynchronously.

Furthermore, in the third aspect, an input rate in a spatial direction of the pulse and an input rate in a time direction of the pulse may be detectable. This brings about an effect that an event rate can be detected asynchronously while stabilizing the counter threshold with respect to a temporal change and a spatial change of a light amount.

Furthermore, in the third aspect, each of the first spiking neurons may include: a high-rate detection first spiking neuron that fires on the basis of an increase in an input rate of the pulse; and a low-rate detection first spiking neuron that fires on the basis of a decrease in an input rate of the pulse, and the second spiking neuron may include: a high-rate detection second spiking neuron connected such that a neuron membrane potential rises on the basis of an input of firing from the high-rate detection first spiking neuron and a neuron membrane potential falls on the basis of an input of firing from the low-rate detection first spiking neuron; and a low-rate detection second spiking neuron connected such that a neuron membrane potential falls on the basis of an input of firing from the high-rate detection first spiking neuron and a neuron membrane potential rises on the basis of an input of firing from the low-rate detection first spiking neuron. This brings about an effect that a counter threshold is updated so as to be up/down according to a low light amount and a high light amount while enabling detection of the event rate asynchronously.

### BRIEF DESCRIPTION OF DRAWINGS

FIG. 1 is a block diagram illustrating a configuration example of an imaging device according to a first embodiment.

FIG. 2 is a block diagram illustrating a configuration example of a solid-state imaging device according to the first embodiment.

FIG. 3 is a block diagram illustrating a configuration example of the solid-state imaging device according to the first embodiment on a layer-by-layer basis.

FIG. 4 is a circuit diagram illustrating a configuration example of a pixel according to the first embodiment.

FIG. 5 is a diagram illustrating a configuration example of a control spiking neural network (SNN) capable of detecting an input rate of an event in a time direction according to the first embodiment.

FIG. 6 is a diagram illustrating firing probabilities of a low-rate detection spiking neuron and a high-rate detection spiking neuron according to the first embodiment.

FIG. 7 is a timing chart illustrating an operation of the control SNN capable of detecting the input rate in the time direction of the event according to the first embodiment.

FIG. 8 is a diagram illustrating a configuration example of a control SNN capable of detecting input rates in a time direction and a spatial direction of an event according to the first embodiment.

FIG. 9 is a timing chart illustrating an operation of the control SNN capable of detecting input rates in the time direction and the spatial direction of the event according to the first embodiment.

FIG. 10 is a block diagram illustrating a configuration example of a solid-state imaging device according to a second embodiment on a layer-by-layer basis.

FIG. 11 is a block diagram illustrating a configuration example of a solid-state imaging device according to a third embodiment on a layer-by-layer basis.

FIG. 12 is a block diagram illustrating a configuration example of a solid-state imaging device according to a fourth embodiment on a layer-by-layer basis.

FIG. 13 is a block diagram illustrating a configuration example of a solid-state imaging device according to a fifth embodiment on a layer-by-layer basis.

FIG. 14 is a block diagram illustrating a configuration example of a control SNN according to a sixth embodiment.

FIG. 15 is a diagram illustrating a configuration example of a control SNN capable of detecting input rates in the time direction and the spatial direction of an event according to the sixth embodiment.

FIG. 16 is a block diagram illustrating a configuration example of a control SNN according to a seventh embodiment.

FIG. 17 is a block diagram illustrating a configuration example of a control SNN according to an eighth embodiment.

FIG. 18 is a block diagram illustrating a configuration example of a distance measurement device according to a ninth embodiment.

FIG. 19 is a block diagram illustrating a schematic configuration example of a vehicle control system.

FIG. 20 is an explanatory diagram illustrating an example of an installation position of an imaging section.

### MODE FOR CARRYING OUT THE INVENTION

Hereinafter, a mode for carrying out the present technology (hereinafter referred to as an embodiment) will be described. The description will be given in the following order.
1. First embodiment (Example of controlling an output rate of an event on the basis of a comparison result between a count value generated by a counter and a counter threshold)
2. Second embodiment (Example of arbitrating an output of an event in a row on the basis of a detection result of the event for each row)
3. Third embodiment (Example of arbitrating an output of an event in each row and each column on the basis of a detection result of the event in each row and each column)
4. Fourth embodiment (Example of controlling a negative power supply voltage of SPAD on the basis of a comparison result between a count value generated by a counter and a counter threshold)
5. Fifth embodiment (Example in which a counter threshold can be controlled over one stage)
6. Sixth embodiment (Example in which a counter threshold can be controlled over a plurality of stages)
7. Seventh embodiment (Example in which a counter threshold can be controlled at a constant rate)
8. Eighth embodiment (Example in which a counter threshold can be controlled on the basis of stage and ratio)
9. Ninth embodiment (Example in which control of an output rate of an event is applied to a distance measurement device)
10. Application example to mobile body

### 1. First Embodiment

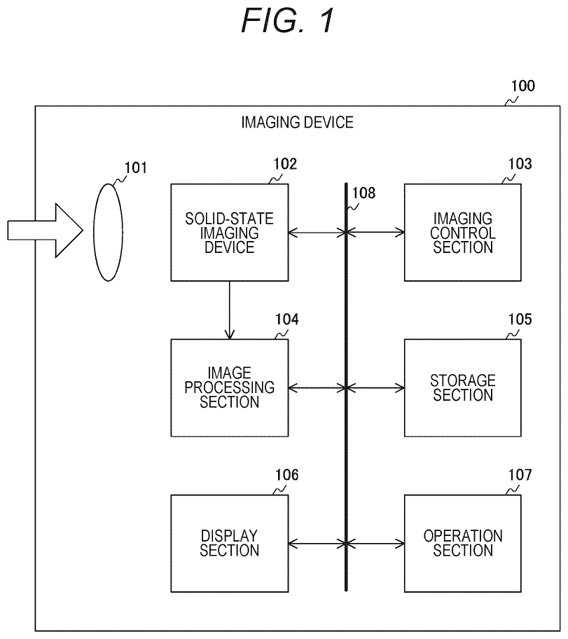

FIG. 1 is a block diagram illustrating a configuration example of an imaging device according to a first embodiment.

In the drawing, an imaging device 100 includes an optical system 101, a solid-state imaging device 102, an imaging control section 103, an image processing section 104, a storage section 105, a display section 106, and an operation section 107. The imaging control section 103, the image processing section 104, the storage section 105, the display section 106, and the operation section 107 are connected to each other via a bus 108. Note that the imaging device 100 may be used alone, may be incorporated in a portable terminal such as a smartphone, or may be incorporated in an authentication device or a monitoring device.

The optical system 101 causes light from a subject to enter the solid-state imaging device 102, and forms a subject image on a light receiving surface of the solid-state imaging device 102. The optical system 101 can include, for example, a focus lens, a zoom lens, a diaphragm, and the like. The optical system 101 may include a plurality of lenses such as a wide-angle lens, a standard lens, and a telephoto lens.

The solid-state imaging device 102 converts light from the subject into an electric signal for each pixel, and digitizes and outputs the electric signal. The solid-state imaging device 102 may be, for example, an event-based vision sensor. The light received by the solid-state imaging device 102 may be visible light, near infrared light (NIR), short wavelength infrared light (SWIR), ultraviolet light, X-rays, or the like.

The imaging control section 103 controls the imaging by the solid-state imaging device 102 on the basis of a command from the operation section 107. At this time, the imaging control section 103 can control exposure conditions, imaging timing, and the like of the solid-state imaging device 102.

The image processing section 104 performs image processing on the basis of the output from the solid-state imaging device 102. The image processing section 104 may include an application processor that executes processing on the basis of software.

The storage section 105 stores a captured image captured by the solid-state imaging device 102, and stores imaging parameters and the like of the solid-state imaging device 102. Furthermore, the storage section 105 can store a program for operating the imaging device 100 on the basis of software. The storage section 105 may include a read only memory (ROM), a random access memory (RAM), and a memory card.

The display section 106 displays a captured image and displays various types of information supporting the imaging operation. The display section 106 may be a liquid crystal display or an organic electro luminescence (EL) display.

The operation section 107 provides a user interface for operating the imaging device 100. The operation section 107 may include, for example, a button, a dial, and a switch provided in the imaging device 100. The operation section 107 may include a touch panel configured together with the display section 106.

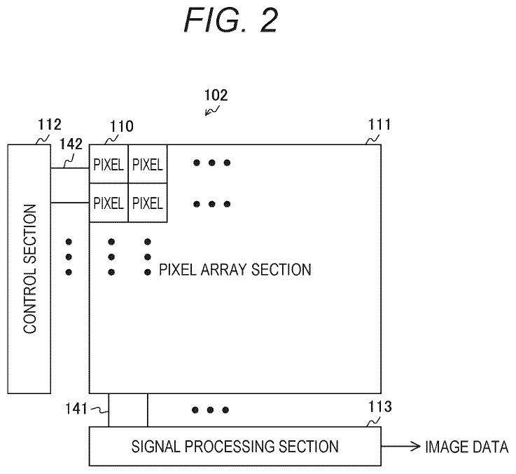

FIG. 2 is a block diagram illustrating a configuration example of the solid-state imaging device according to the first embodiment.

In the drawing, the solid-state imaging device 102 includes a control section 112, a pixel array section 111, and a signal processing section 113. These circuits may be disposed on a single semiconductor substrate or may be disposed on a stacked substrate.

In the pixel array section 111, the pixels 110 are arranged in a maritox shape in the row direction and the column direction. Each pixel 110 is connected to a signal line 141 for each column, and is connected to a control line 142 for each row. The pixel 110 outputs, as pixel data, an event generated on the basis of a comparison result between a count value of a pulse generated according to incidence of a photon and a count threshold. Note that the event is a signal indicating a change in luminance of the incident light in the same direction. At this time, the pixel 110 can include a light receiving section and a circuit section. The circuit section may be disposed below the light receiving section. The light receiving section may include a single photon avalanche diode (SPAD). The light receiving section may be a photodiode. In each pixel 110, the circuit section can output an event to the signal line 141 on the basis of a comparison result between the count value of the pulse output from the light receiving section and the counter threshold.

The control section 112 sequentially selects rows in synchronization with the vertical synchronization signal. At this time, the control section 112 can select the pixel 110 via the control line 142. The control section 112 may include a vertical arbiter that arbitrates the selection of a row including the pixel 110 in which the event is detected. The signal processing section 113 executes various types of signal processing on the image data in which the pixel data is arranged. The signal processing section 113 may include a line scanner that scans a column. The signal processing section 113 may include a horizontal arbiter that arbitrates the selection of the column including the pixel 110 in which the event is detected.

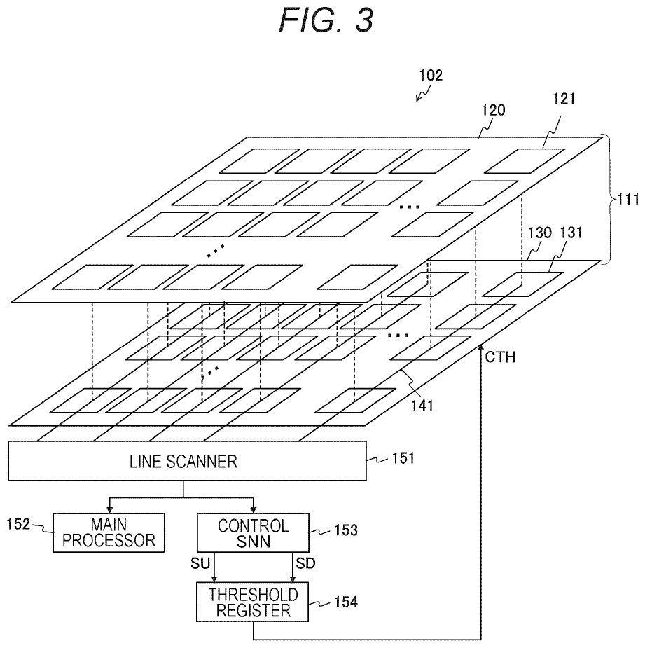

FIG. 3 is a block diagram illustrating a specific example of the solid-state imaging device according to the first embodiment.

In the drawing, the pixel array section 111 includes a light receiving array section 120 and a circuit array section 130. The light receiving array section 120 can be stacked on the circuit array section 130. The light receiving array section 120 includes light receiving sections 121. The light receiving sections 121 are arranged in a maritox shape in the row direction and the column direction. The circuit array section 130 includes circuit sections 131. The circuit sections 131 are arranged in a maritox shape in the row direction and the column direction. At this time, each pixel 110 can include each of the light receiving sections 121 and each of the circuit sections 131. The circuit section 131 can be disposed immediately below the light receiving section 121.

The circuit section 131 can generate an event by compressing the rate of the pulse output from the light receiving section 121 and output the event to the signal line 141. At this time, the circuit section 131 can output the event to the signal line 141 on the basis of a comparison result between a count value of a pulse output from the light receiving section 121 and a counter threshold CTH. In the generation of the event, the exposure may be left. At this time, a non-exposure period may not be provided.

The signal processing section 113 includes a line scanner 151, a main processor 152, a control SNN 153, and a threshold register 154.

The line scanner 151 scans the signal line 141 for each column and reads an event from the signal line 141 for each column.

The main processor 152 processes events read by the line scanner 151. For example, the main processor 152 may configure an image for viewing or may configure an image for sensing on the basis of the event. Furthermore, the main processor 152 may perform image processing on these images.

The control SNN 153 updates the counter threshold CTH on the basis of the input rate of the event output from the circuit section 131. At this time, the control SNN 153 can detect the input rate in the spatial direction of the event and the input rate in the time direction of the event. The control SNN 153 may update the counter threshold CTH stepwise, or at a constant rate, or in a mixed manner, both stepwise and at a constant rate. At this time, the control SNN 153 may generate an up signal SU for increasing the counter threshold CTH and a down signal SD for decreasing the counter threshold CTH.

The threshold register 154 stores a counter threshold CTH for the count value of the pulse output from the light receiving section 121, and outputs the counter threshold CTH to the circuit section 131. The threshold register 154 can update the counter threshold CTH on the basis of the up signal SU and the down signal SD from the control SNN 153.

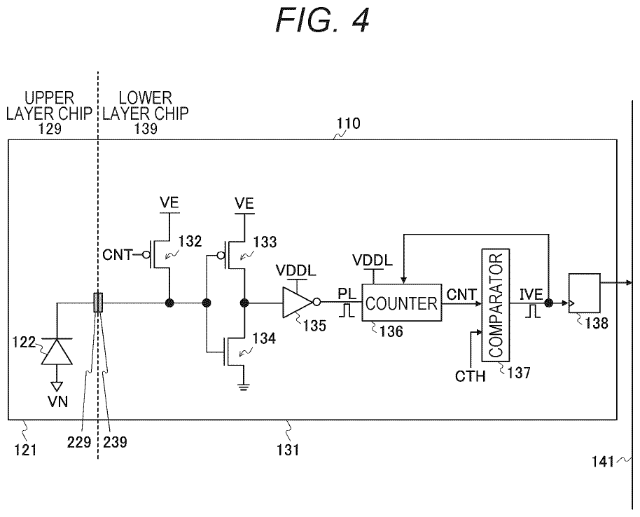

FIG. 4 is a circuit diagram illustrating a configuration example of a pixel according to the first embodiment.

In the drawing, the pixel 110 includes a SPAD 122, a quench resistor 132, a P-channel transistor 133, an N-channel transistor 134, an inverter 135, a counter 136, a comparator 137, and a latch circuit 138.

The SPAD 122 detects photons one by one. At this time, the SPAD 122 can amplify a current on the basis of the avalanche amplification. However, in the SPAD 122, a negative voltage VN is set such that a voltage higher than the breakdown voltage is applied. At this time, an amplification factor of the avalanche amplification is theoretically infinite. For this reason, the SPAD 122 can generate a saturation output current without depending on an incident amount of photons per unit time, and can detect photons one by one.

The quench resistor 132 forcibly stops avalanche amplification of the SPAD 122. The quench resistor 132 may use a resistance component of a MOS transistor. A power supply voltage VE may be applied to the MOS transistor. At this time, the resistance value of the quench resistor 132 can be set on the basis of a control signal CNT applied to the gate of the MOS transistor. A reverse voltage higher than the breakdown voltage is set to the SPAD 122 via the quench resistor 132. For this reason, when a current flows through the SPAD 122 on the basis of the avalanche amplification, the voltage applied to the SPAD 122 decreases on the basis of the voltage drop by the quench resistor 132, and the avalanche amplification stops.

The P-channel transistor 133 and the N-channel transistor 134 are connected in series. The gate of the P-channel transistor 133 and the gate of the N-channel transistor 134 are connected to the cathode of the SPAD 122. The power supply voltage VE may be applied to the P-channel transistor 133.

The inverter 135 generates a pulse PL on the basis of an output from a connection point between the P-channel transistor 133 and the N-channel transistor 134, and outputs the pulse PL to the counter 136. A power supply voltage VDDL may be applied to the inverter 135. The power supply voltage VDDL can be lower than the power supply voltage VE.

The counter 136 counts the pulse PL output from the inverter 135 and outputs a count value CNT to the comparator 137. The power supply voltage VDDL may be applied to the counter 136.

The comparator 137 outputs an event IVE on the basis of a comparison result between the count value by the counter 136 and the counter threshold CTH. For example, the comparator 137 can output-IVE the event when the count value exceeds a counter threshold CTH. Furthermore, the comparator 137 can reset the counter 136 when the count value exceeds the counter threshold CTH. At this time, the comparator 137 can adjust the output rate of the event IVE on the basis of the counter threshold CTH.

The latch circuit 138 latches the event IVE output from the comparator 137. Then, the latch circuit 138 outputs the event IVE to the signal line 141 on the basis of the designated timing.

The pixel 110 may be formed in a stacked chip. At this time, the SPAD 122 may be formed on an upper layer chip 129. In a lower layer chip 139, the quench resistor 132, the P-channel transistor 133, the N-channel transistor 134, the inverter 135, the counter 136, the comparator 137, and the latch circuit 138 may be formed.

The lower layer chip 139 and the upper layer chip 129 may be directly bonded. At this time, pad electrodes 229 and 239 can be formed on the lower layer chip 139 and the upper layer chip 129, respectively. The pad electrode 239 is connected to the quench resistor 132, the gate of the P-channel transistor 133, and the gate of the N-channel transistor 134. The pad electrode 229 is connected to the SPAD 122. The pad electrodes 229 and 239 can be disposed to face each other. In the direct bonding of the lower layer chip 139 and the upper layer chip 129, hybrid bonding can be used. At this time, the pad electrodes 229 and 239 can be Cu-Cu connected. The material of the semiconductor substrate used for the lower layer chip 139 and the upper layer chip 129 may be Si, InGaAs, or InP.

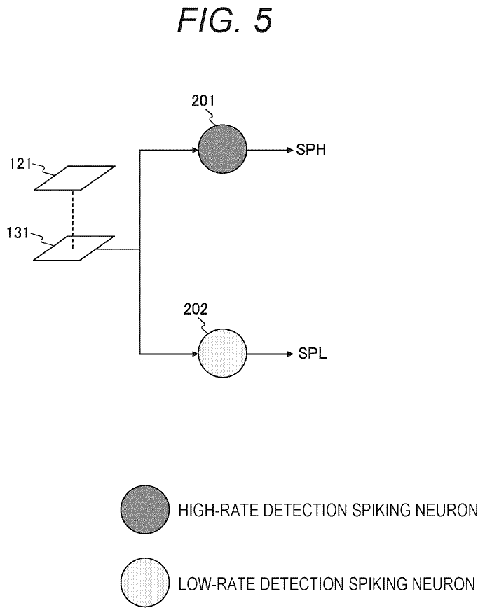

FIG. 5 is a diagram illustrating a configuration example of a control SNN capable of detecting an input rate of an event in a time direction according to the first embodiment.

In the drawing, the control SNN 153 is provided with a high-rate detection spiking neuron 201 and a low-rate detection spiking neuron 202. The event IVE generated by the circuit section 131 is input to the high-rate detection spiking neuron 201 and the low-rate detection spiking neuron 202. The high-rate detection spiking neuron 201 outputs a high-rate detection spike SPH on the basis of the event IVE generated by the circuit section 131. The low-rate detection spiking neuron 202 outputs a low-rate detection spike SPL on the basis of the event IVE generated by the circuit section 131.

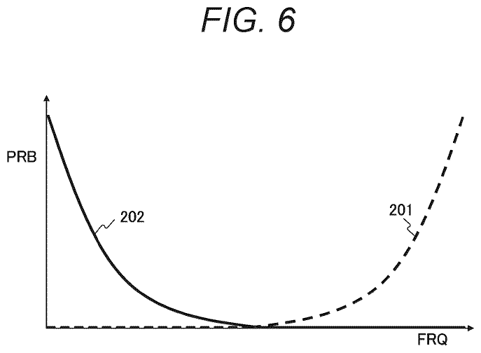

FIG. 6 is a diagram illustrating firing probabilities of a low-rate detection spiking neuron and a high-rate detection spiking neuron according to the first embodiment.

In the drawing, in the high-rate detection spiking neuron 201, a firing probability PRB increases as an output rate FRQ of the event IVE generated in the circuit section 131 increases. In the low-rate detection spiking neuron 202, the firing probability PRB increases as the output rate FRQ of the event IVE generated in the circuit section 131 decreases.

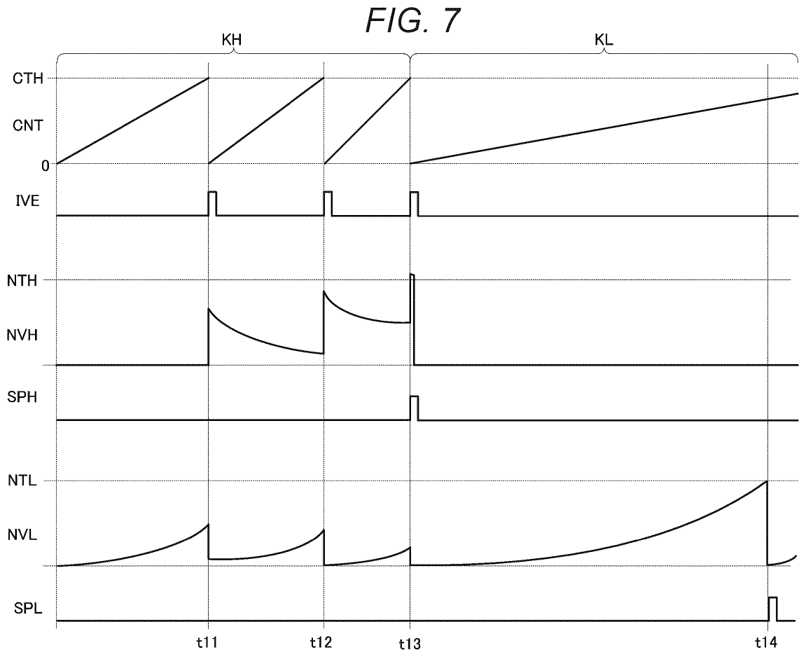

FIG. 7 is a timing chart illustrating an operation of the control SNN capable of detecting the input rate in the time direction of the event according to the first embodiment.

In the drawing, a neuron threshold NTH is set to the high-rate detection spiking neuron 201, and a neuron threshold NTL is set to the low-rate detection spiking neuron 202. Furthermore, in the high-rate detection spiking neuron 201, a neuron membrane potential NVH rises when a pulse is input, and the neuron membrane potential NVH gradually decreases when no pulse is input. In the low-rate detection spiking neuron 202, the neuron membrane potential NVL gradually increases when no pulse is input, and the neuron membrane potential NVH falls when a pulse is input.

Then, in a high light amount period KH, the pulse PL is input to the counter 136 on the basis of the incidence of photons to the SPAD 122. Every time the pulse PL is input to the counter 136, the count value CNT is counted up and input to the comparator 137. Then, in the comparator 137, when the count value CNT reaches the counter threshold CTH, the event IVE is output from the comparator 137 to the signal line 141, and the counter 136 is reset (from time T11 to t13).

The event IVE output to the signal line 141 is input to the high-rate detection spiking neuron 201 and the low-rate detection spiking neuron 202. Then, in the high-rate detection spiking neuron 201, when the output rate FRQ of the event IVE from the circuit section 131 increases and the input of the next event IVE is repeated before the neuron membrane potential NVH completely falls, the neuron membrane potential NVH reaches the neuron threshold NTH. Then, when the neuron membrane potential NVH reaches the neuron threshold NTH, the high-rate detection spiking neuron 201 generates the high-rate detection spike SPH. At this time, the high-rate detection spiking neuron 201 can output the high-rate detection spike SPH to the threshold register 154 as the up signal SU.

When the up signal SU is input, the threshold register 154 increases the counter threshold CTH and outputs it to the circuit section 131. In the circuit section 131, when the counter threshold CTH is increased, the output rate of the event IVE decreases, and saturation of the event IVE in the high light amount period KH can be suppressed.

On the other hand, in a low light amount period KL, the pulse PL is input to the counter 136 on the basis of the incidence of photons to the SPAD 122. Every time the pulse PL is input to the counter 136, the count value CNT is counted up and input to the comparator 137. Then, in the comparator 137, when a state in which the count value CNT does not reach the counter threshold CTH continues, a state in which the event IVE is not input to the low-rate detection spiking neuron 202 continues. Then, when the state in which the event IVE is not input to the low-rate detection spiking neuron 202 continues, the neuron membrane potential NVL gradually increases, and the neuron membrane potential NVL reaches the neuron threshold NTL. Then, when the neuron membrane potential NVL reaches the neuron threshold NTL, the low-rate detection spiking neuron 202 generates the low-rate detection spike SPL (t14). At this time, the low-rate detection spiking neuron 202 can output the low-rate detection spike SPL to the threshold register 154 as the down signal SD.

When the down signal SD is input, the threshold register 154 decreases the counter threshold CTH and outputs it to the circuit section 131. In the circuit section 131, when the counter threshold CTH is decreased, the output rate of the event IVE increases, and missing of the event IVE in the low light amount period KL can be suppressed.

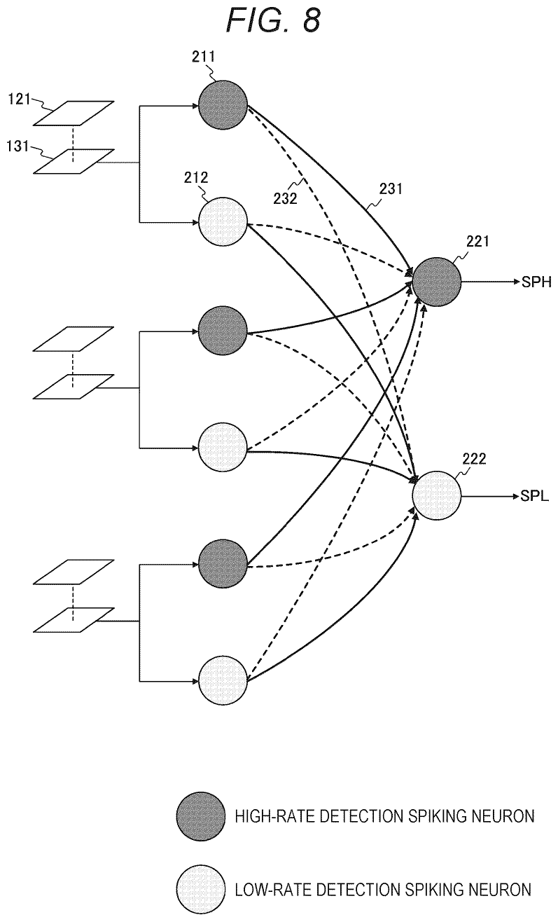

FIG. 8 is a diagram illustrating a configuration example of a control SNN capable of detecting input rates in a time direction and a spatial direction of an event according to the first embodiment. Note that, in the drawing, in order to enable detection of the input rate in the spatial direction, the configuration of the control SNNs 153 for three pixels having different spatial positions is taken as an example, but the control SNNs 153 may correspond to a larger number of pixels.

In the drawing, a first layer and a second layer are provided in the control SNN 153. In the first layer of the control SNN 153, a high-rate detection spiking neuron 211 and a low-rate detection spiking neuron 212 are provided for each circuit section 131. A high-rate detection spiking neuron 221 and a low-rate detection spiking neuron 222 are provided in the second layer of the control SNN 153.

A positive connection 231 is provided between the high-rate detection spiking neuron 211 and the high-rate detection spiking neuron 221. A negative connection 232 is provided between the high-rate detection spiking neuron 211 and the low-rate detection spiking neuron 222. The negative connection 232 is provided between the low-rate detection spiking neuron 212 and the high-rate detection spiking neuron 221. The positive connection 231 is provided between the low-rate detection spiking neuron 212 and the low-rate detection spiking neuron 222.

The positive connection 231 may raise a neuron membrane potential NVH of the high-rate detection spiking neuron 221 on the basis of a pulse input to the high-rate detection spiking neuron 221. Furthermore, the positive connection 231 can raise a neuron membrane potential NVL of the low-rate detection spiking neuron 222 on the basis of the pulse input to the low-rate detection spiking neuron 222. On the other hand, the negative connection 232 can lower the neuron membrane potential NVH of the high-rate detection spiking neuron 221 on the basis of a pulse input to the high-rate detection spiking neuron 221. Furthermore, the negative connection 232 can lower the neuron membrane potential NVL of the low-rate detection spiking neuron 222 on the basis of a pulse input to the low-rate detection spiking neuron 222.

The event IVE generated in the circuit section 131 is input to the high-rate detection spiking neuron 211 and the low-rate detection spiking neuron 212 for each circuit section 131. The high-rate detection spiking neuron 221 outputs a high-rate detection spike SPH on the basis of the positive connection 231 with the high-rate detection spiking neuron 211 and the negative connection 232 with the low-rate detection spiking neuron 212. The low-rate detection spiking neuron 222 outputs a low-rate detection spike SPL on the basis of the negative connection 232 with the high-rate detection spiking neuron 211 and the positive connection 231 with the low-rate detection spiking neuron 212.

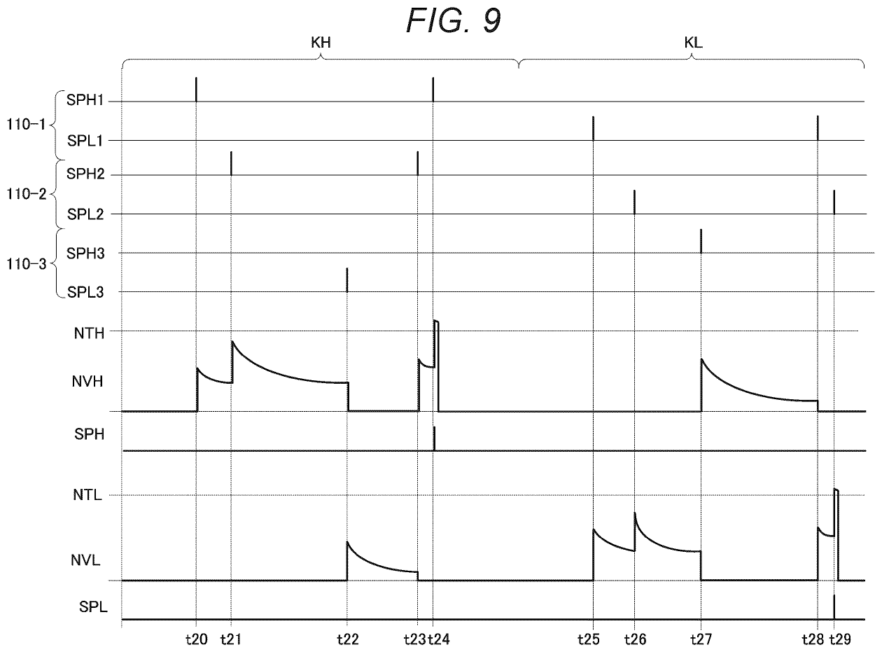

FIG. 9 is a timing chart illustrating an operation of the control SNN capable of detecting input rates in the time direction and the spatial direction of the event according to the first embodiment. Note that, in the drawing, the operation of the control SNN 153 for the three pixels 110-1 to 110-3 having different spatial positions is taken as an example.

In the drawing, a neuron threshold NTH is set to the high-rate detection spiking neuron 221, and a neuron threshold NTL is set to the low-rate detection spiking neuron 222. Furthermore, in the high-rate detection spiking neuron 221, when a pulse is input via the positive connection 231, a neuron membrane potential NVH rises, and when a pulse is input via the negative connection 232, the neuron membrane potential NVH falls. Furthermore, in the high-rate detection spiking neuron 221, the neuron membrane potential NVH gradually decreases when no pulse is input. In the low-rate detection spiking neuron 222, when a pulse is input via the positive connection 231, a neuron membrane potential NVL falls, and when a pulse is input via the negative connection 232, the neuron membrane potential NVL rises. Furthermore, in the low-rate detection spiking neuron 222, the neuron membrane potential NVL gradually decreases when no pulse is input.

Then, in a high light amount period KH, in each of the pixels 110-1 to 110-3, a pulse PL is input to the counter 136 on the basis of the incidence of photons to the SPAD 122. Every time the pulse PL is input to the counter 136, the count value CNT is counted up and input to the comparator 137. Then, in the comparator 137, when the count value CNT reaches the counter threshold CTH, the event IVE is output from the comparator 137 to the signal line 141, and the counter 136 is reset.

The event IVE output to the signal line 141 is input to the high-rate detection spiking neuron 211 and the low-rate detection spiking neuron 212 for each of the pixels 110-1 to 110-3.

Here, in the high light amount period KH, it is assumed that a high light amount is incident on the pixels 110-1 and 110-2 and a low light amount is incident on the pixel 110-3. At this time, in the high-rate detection spiking neuron 221, when high-rate detection spikes SPH1 and SPH2 are output from the pixels 110-1 and 110-2, the neuron membrane potential NVH rises (times t20 and t21). Furthermore, in the high-rate detection spiking neuron 221, when a low-rate detection spike SPL3 is output from the pixel 110-3, the neuron membrane potential NVH falls (time t22). Then, in the high-rate detection spiking neuron 221, when the high-rate detection spikes SPH1 and SPH2 are output from the pixels 110-1 and 110-2 at a high rate, the neuron membrane potential NVH reaches the neuron threshold NTH (times t23 and t24). Then, when the neuron membrane potential NVH reaches the neuron threshold NTH, the high-rate detection spiking neuron 221 generates a high-rate detection spike SPH. At this time, the high-rate detection spiking neuron 221 can output the high-rate detection spike SPH to the threshold register 154 as the up signal SU.

When the up signal SU is input, the threshold register 154 increases the counter threshold CTH and outputs it to each of the pixels 110-1 to 110-3. In each of the pixels 110-1 to 110-3, when the counter threshold CTH is increased, the output rate of the event IVE decreases, and saturation of the event IVE in the high light amount period KH can be suppressed.

On the other hand, in a low light amount period KL, in each of the pixels 110-1 to 110-3, the pulse PL is input to the counter 136 on the basis of the incidence of photons on the SPAD 122. Every time the pulse PL is input to the counter 136, the count value CNT is counted up and input to the comparator 137. Then, in the comparator 137, when the count value CNT reaches the counter threshold CTH, the event IVE is output from the comparator 137 to the signal line 141, and the counter 136 is reset.

The event IVE output to the signal line 141 is input to the high-rate detection spiking neuron 211 and the low-rate detection spiking neuron 212 for each of the pixels 110-1 to 110-3.

Here, in the low light amount period KL, it is assumed that a low light amount is incident on the pixels 110-1 and 110-2 and a high light amount is incident on the pixel 110-3. At this time, in the low-rate detection spiking neuron 222, when low-rate detection spikes SPL1 and SPL2 are output from the pixels 110-1 and 110-2, the neuron membrane potential NVL rises (times t25 and t26). Furthermore, in the low-rate detection spiking neuron 222, when a high-rate detection spike SPH3 is output from the pixel 110-3, the neuron membrane potential NVL falls (time t27). Then, in the low-rate detection spiking neuron 222, when the low-rate detection spikes SPL1 and SPL2 are output from the pixels 110-1 and 110-2 at a high rate, the neuron membrane potential NVL reaches the neuron threshold NTL (times t28 and t29). Then, when the neuron membrane potential NVL reaches the neuron threshold NTL, the low-rate detection spiking neuron 222 generates a low-rate detection spike SPL. At this time, the low-rate detection spiking neuron 222 can output the low-rate detection spike SPL to the threshold register 154 as the down signal SD.

When the down signal SD is input, the threshold register 154 decreases the counter threshold CTH and outputs it to each of the pixels 110-1 to 110-3. In each pixel 110-1 to 110-3, when the counter threshold CTH is decreased, the output rate of the event IVE increases, and missing of the event IVE in the low light amount period KL can be suppressed.

As described above, in the first embodiment described above, each pixel 110 controls the output rate of the event IVE on the basis of the comparison result between the count value CNT generated by the counter 136 and the counter threshold CTH. Therefore, the solid-state imaging device 102 can suppress saturation of the event output and lack of the event output while suppressing a decrease in sensitivity.

Furthermore, in order to control the output rate of the event on the basis of the counter threshold CTH, the control SNN 153 is used to update the counter threshold CTH. Therefore, it is possible to control the input rate in the spatial direction of the event IVE and the input rate in the time direction of the event IVE while enabling the asynchronous input of the event IVE. For this reason, it is possible to stabilize the counter threshold CTH with respect to the temporal change and the spatial change of the light amount, and it is possible to reduce the power consumption and the delay as compared with the method of synchronizing the inputs of the event IVE. For example, it is possible to stabilize the counter threshold CTH while achieving low power consumption and low delay even in an illumination environment in which there is flicker under a fluorescent light and a surrounding environment during traveling at an entrance and an exit of a tunnel.

### 2. Second Embodiment

In the first embodiment described above, the output rate of the event IVE is controlled on the basis of the comparison result between the count value CNT generated by the counter and the counter threshold CTH. In a second embodiment, the output of the event IVE in the row is arbitrated on the basis of a detection result of the event IVE for each row.

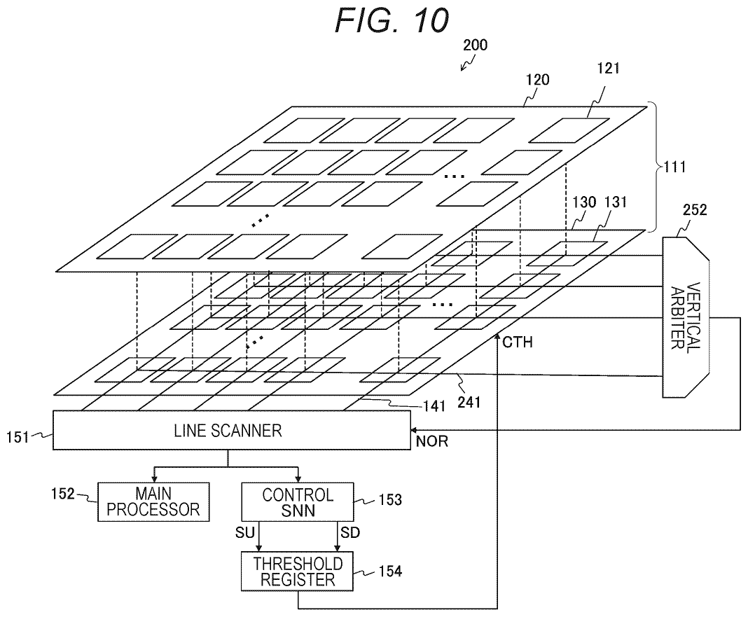

FIG. 10 is a block diagram illustrating a configuration example of the solid-state imaging device according to the second embodiment on a layer-by-layer basis.

In the drawing, a solid-state imaging device 200 includes a vertical arbiter 252 in the control section 112 of the first embodiment described above. Other configurations of the solid-state imaging device 200 of the second embodiment are similar to those of the solid-state imaging device 102 of the first embodiment described above.

The vertical arbiter 252 arbitrates an output of an event IVE in the row on the basis of a detection result of the event IVE for each row. The vertical arbiter 252 is connected to a circuit section 131 for each row via a control line 241. At this time, the vertical arbiter 252 can be connected to an output of a latch circuit 138 in the circuit section 131.

When detecting the output of the event IVE in any row, the vertical arbiter 252 outputs a row number NOR of the row to a line scanner 151. When the row number NOR is output from the vertical arbiter 252, the line scanner 151 can scan the row specified by the row number NOR and read the event IVE from the row.

As described above, in the second embodiment described above, the vertical arbiter 252 arbitrates the output of the event IVE in the row on the basis of the detection result of the event IVE for each row. Therefore, the line scanner 151 can scan only the row in which the event IVE has occurred. For this reason, the line scanner 151 does not need to scan a row in which no event IVE has occurred, and can improve the effect of compressing the output rate of the event IVE.

### 3. Third Embodiment

In the second embodiment described above, the output of the event IVE in the row is arbitrated on the basis of the detection result of the event IVE for each row. In a third embodiment, an output of an event IVE in each row and each column is arbitrated on the basis of a detection result of the event IVE in each row and each column.

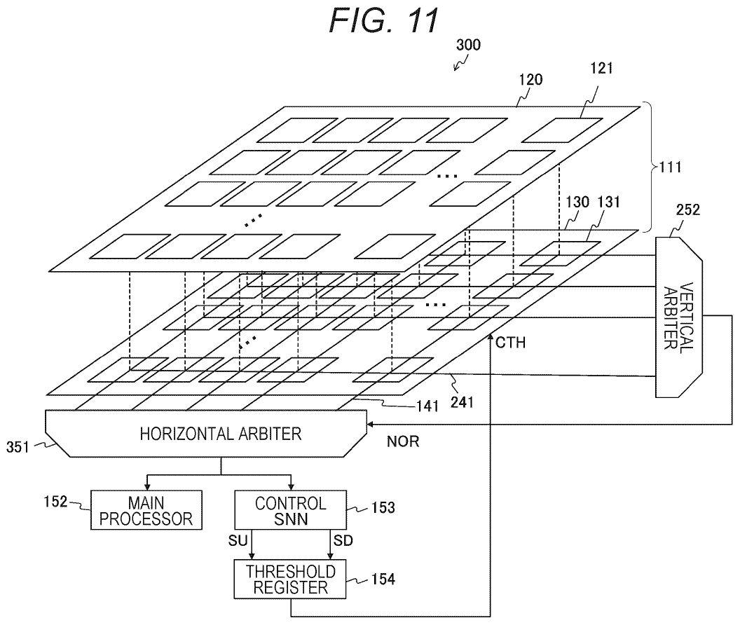

FIG. 11 is a block diagram illustrating a configuration example of a solid-state imaging device according to the third embodiment on a layer-by-layer basis.

In the drawing, a solid-state imaging device 300 includes a horizontal arbiter 351 instead of the line scanner 151 of the second embodiment described above. Other configurations of the solid-state imaging device 300 of the third embodiment are similar to those of the solid-state imaging device 200 of the second embodiment described above.

The horizontal arbiter 351 arbitrates an output of an event IVE in the column on the basis of a detection result of the event IVE for each column. The horizontal arbiter 351 is connected to a circuit section 131 for each column via a signal line 141. At this time, the horizontal arbiter 351 can be connected to an output of a latch circuit 138 in the circuit section 131.

When detecting the output of the event IVE in any row, a vertical arbiter 252 outputs a row number NOR of the row to the horizontal arbiter 351. When the row number NOR is output from the vertical arbiter 252, the horizontal arbiter 351 can read the event IVE from the column in which the event IVE has occurred in the row specified by the row number NOR.

As described above, in the third embodiment, the vertical arbiter 252 arbitrates the output of the event IVE in the row on the basis of the detection result of the event IVE for each row, and the horizontal arbiter 351 arbitrates the output of the event IVE in the column on the basis of the detection result of the event IVE for each column. Therefore, the horizontal arbiter 351 can read the event IVE only from the pixel 110 in which the event IVE has occurred. For this reason, the horizontal arbiter 351 does not need to scan the pixel 110 in which the event IVE does not occur, and the effect of compressing the output rate of the event IVE can be improved.

### 4. Fourth Embodiment

In the first embodiment described above, the output rate of the event IVE is controlled on the basis of the comparison result between the count value CNT generated by the counter and the counter threshold CTH. In a fourth embodiment, a negative power supply voltage VN of a SPAD 122 is controlled on the basis of a comparison result between a count value CNT generated by a counter 136 and a counter threshold CTH.

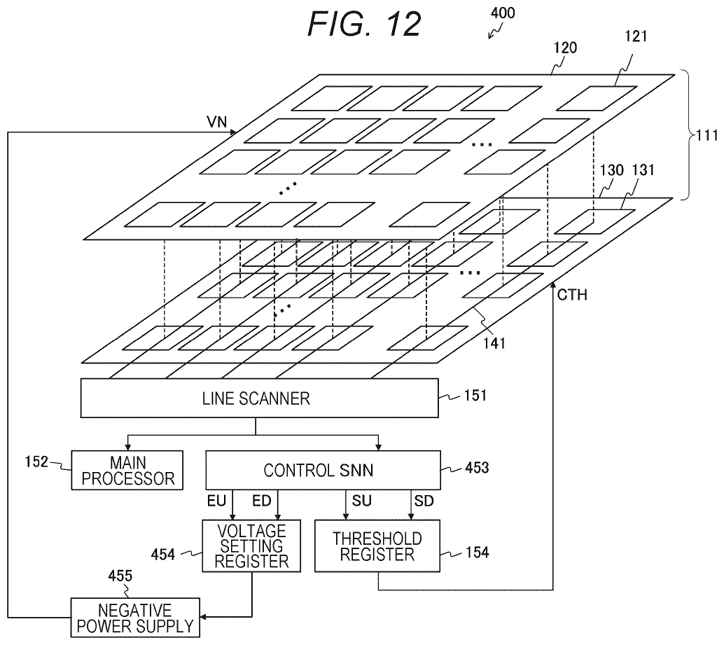

FIG. 12 is a block diagram illustrating a configuration example of a solid-state imaging device according to the fourth embodiment on a layer-by-layer basis.

In the drawing, in a solid-state imaging device 400, a voltage setting register 454 and a negative power supply 455 are added to the solid-state imaging device 102 of the first embodiment described above. Furthermore, the solid-state imaging device 400 includes a control SNN 453 instead of the control SNN 153 of the first embodiment described above. Other configurations of the solid-state imaging device 400 of the fourth embodiment are similar to those of the solid-state imaging device 102 of the first embodiment described above.

The control SNN 453 updates the counter threshold CTH and the negative power supply voltage VN on the basis of an input rate of an event IVE output from a circuit section 131. At this time, the control SNN 453 can detect the input rate in the spatial direction of the event IVE and the input rate in the time direction of the event IVE. The control SNN 453 may update the counter threshold CTH and the negative power supply voltage VN stepwise, or at a constant rate, or in a mixed manner, both stepwise and at a constant rate. At this time, the control SNN 453 may generate an up signal SU for increasing the counter threshold CTH and a down signal SD for decreasing the counter threshold CTH. Furthermore, the control SNN 453 may generate an up signal EU for increasing the negative power supply voltage VN and a down signal ED for decreasing the negative power supply voltage VN.

The control SNN 453 may be configured similarly to the control SNN 153 of the first embodiment described above. At this time, in addition to the high-rate detection spiking neuron and the low-rate detection spiking neuron used for updating the counter threshold CTH, a high-rate detection spiking neuron and a low-rate detection spiking neuron used for updating the negative power supply voltage VN may be provided in a second layer of the control SNN 453.

The voltage setting register 454 stores a set value of the negative power supply voltage VN and outputs the set value to the negative power supply 455. The voltage setting register 454 can update the set value of the negative power supply voltage VN on the basis of the up signal EU and the down signal ED from the control SNN 453.

The negative power supply 455 raises and lowers the negative power supply voltage VN on the basis of the up signal EU and the down signal ED output from the voltage setting register 454, and supplies the negative power supply voltage VN to the SPAD 122.

As described above, in the above-described fourth embodiment, the control SNN 453 controls the negative power supply voltage VN of the SPAD 122 on the basis of the input rate of the event IVE. Therefore, the solid-state imaging device 400 can adjust the sensitivity of a light receiving section 121 according to an amount of light received by the light receiving section 121.

Furthermore, in order to control the negative power supply voltage VN of the SPAD 122 on the basis of the output rate of the event IVE, the control SNN 453 is used to update the negative power supply voltage VN. Therefore, it is possible to control the input rate in the spatial direction of the event IVE and the input rate in the time direction of the event IVE while enabling the asynchronous input of the event IVE. For this reason, it is possible to stabilize the negative power supply voltage VN with respect to the temporal change and the spatial change of the light amount, and it is possible to achieve low power consumption and low delay as compared with the method of synchronizing the inputs of the event IVE.

### 5. Fifth Embodiment

In the first embodiment described above, the control SNN 153 generates the up signal SU for increasing the counter threshold CTH and the down signal SD for decreasing the counter threshold CTH. In a fifth embodiment, a control SNN generates an up signal SU1 that increases a counter threshold CTH by one step and a down signal SD1 that decreases the counter threshold CTH by one stage.

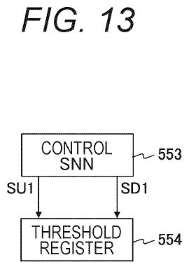

FIG. 13 is a block diagram illustrating a configuration example of a control SNN according to the fifth embodiment.

In the drawing, a control SNN 553 generates the up signal SU1 that increases the counter threshold CTH by one step and the down signal SD1 that decreases the counter threshold CTH by one stage.

A threshold register 554 stores the counter threshold CTH for a count value CNT of a pulse output from a light receiving section 121, and outputs the counter threshold CTH to a circuit section 131. The threshold register 554 can update the counter threshold CTH on the basis of the up signal SU1 and the down signal SD1 from the control SNN 553.

The control SNN 553 and the threshold register 554 may be applied to any of the solid-state imaging devices of the first to fourth embodiments described above.

As described above, in the above-described fifth embodiment, the control SNN 553 increases or decreases the counter threshold CTH by one stage. Therefore, it is possible to control the input rate in the spatial direction of the event IVE and the input rate in the time direction of the event IVE while suppressing the enlargement of the configuration of the control SNN 553, and it is possible to input the event IVE asynchronously.

### 6. Sixth Embodiment

In the above-described fifth embodiment, the control SNN 553 increases or decreases the counter threshold CTH by one stage. In a sixth embodiment, a control SNN increases or decreases a counter threshold CTH over two stages.

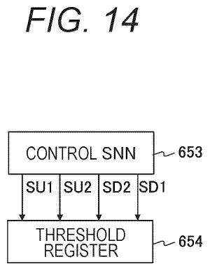

FIG. 14 is a block diagram illustrating a configuration example of a control SNN according to the sixth embodiment.

In the drawing, a control SNN 653 generates up signals SU1 and SU2 that increase the counter threshold CTH over two stages and down signals SD1 and SD2 that decrease the counter threshold CTH over two stages.

A threshold register 654 stores the counter threshold CTH for a count value CNT of a pulse output from a light receiving section 121, and outputs the counter threshold CTH to a circuit section 131. The threshold register 654 can update the counter threshold CTH on the basis of the up signals SU1 and SU2 and the down signals SD1 and SD2 from the control SNN 653.

The control SNN 653 and the threshold register 654 may be applied to any of the solid-state imaging devices of the first to fourth embodiments described above.

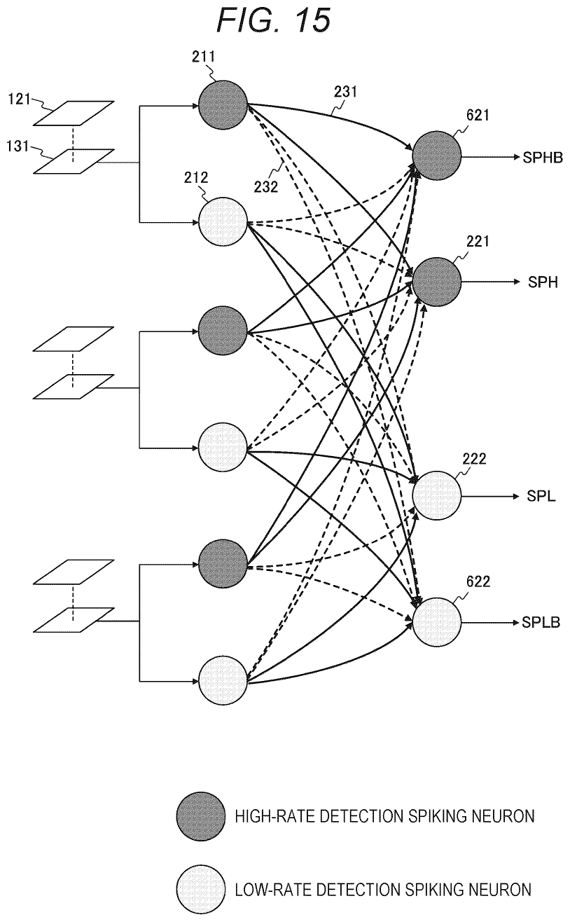

FIG. 15 is a diagram illustrating a configuration example of a control SNN capable of detecting input rates in the time direction and the spatial direction of an event according to the sixth embodiment.

In the drawing, in the control SNN 653, a high-rate detection spiking neuron 621 and a low-rate detection spiking neuron 622 are added to the second layer of the control SNN 153 of the first embodiment described above. The rest of the configuration of the control SNN 653 of the sixth embodiment is similar to the configuration of the control SNN 153 of the first embodiment described above.

A neuron threshold NTH2 is set to the high-rate detection spiking neuron 621, and a neuron threshold NTL2 is set to the low-rate detection spiking neuron 622. The neuron thresholds NTH and NTH2 can be different from each other. The neuron thresholds NTL and NTL2 can be different from each other. Therefore, the reaction conditions of the high-rate detection spiking neurons 221 and 621 and the reaction conditions of the low-rate detection spiking neurons 222 and 622 can be made different from each other, and the counter threshold CTH can be moved up and down over two stages.

A positive connection 231 is provided between a high-rate detection spiking neuron 211 and the high-rate detection spiking neuron 621. A negative connection 232 is provided between the high-rate detection spiking neuron 211 and the low-rate detection spiking neuron 622. The negative connection 232 is provided between a low-rate detection spiking neuron 212 and the high-rate detection spiking neuron 621. The positive connection 231 is provided between the low-rate detection spiking neuron 212 and the low-rate detection spiking neuron 622.

The high-rate detection spiking neuron 621 outputs a high-rate detection spike SPHB on the basis of the positive connection 231 with the high-rate detection spiking neuron 211 and the negative connection 232 with the low-rate detection spiking neuron 212. The low-rate detection spiking neuron 622 outputs a low-rate detection spike SPLB on the basis of the negative connection 232 with the high-rate detection spiking neuron 211 and the positive connection 231 with the low-rate detection spiking neuron 212. The high-rate detection spike SPH can be used as the up signal SU1. The high-rate detection spike SPHB can be used as the up signal SU2. The low-rate detection spike SPL can be used as the down signal SD1. The low-rate detection spike SPLB can be used as the down signal SD2.

As described above, in the above-described sixth embodiment, the control SNN 653 increases or decreases the counter threshold CTH by two stages. Therefore, it is possible to more finely update the counter threshold CTH while suppressing the enlargement of the configuration of the control SNN 653, and it is possible to control the event rate of the event IVE asynchronously.

### 7. Seventh Embodiment

In the above-described fifth embodiment, the control SNN 553 increases or decreases the counter threshold CTH by one stage. In a seventh embodiment, a counter threshold CTH is increased or decreased on the basis of a rate.

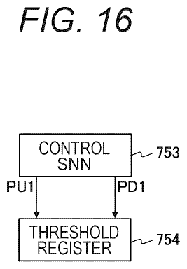

FIG. 16 is a block diagram illustrating a configuration example of a control SNN according to the seventh embodiment.

In the drawing, a control SNN 753 generates an up signal PU1 that increases the counter threshold CTH by a constant rate and a down signal PD1 that decreases the counter threshold CTH by a constant rate. The rate at which the counter threshold CTH is increased or decreased may be, for example, 10% or 20%.

A threshold register 754 stores the counter threshold CTH for a count value CNT of a pulse output from a light receiving section 121, and outputs the counter threshold CTH to a circuit section 131. The threshold register 754 can update the counter threshold CTH on the basis of the up signal PU1 and the down signal PD1 from the control SNN 753.

The control SNN 753 and the threshold register 754 may be applied to any of the solid-state imaging devices of the first to fourth embodiments described above.

As described above, in the above-described seventh embodiment, the control SNN 753 increases or decreases the counter threshold CTH by a constant rate. As a result, it is possible to detect the input rate in the spatial direction of the event IVE and the input rate in the time direction of the event IVE while suppressing the enlargement of the configuration of the control SNN 753, and it is possible to control the event rate of the event IVE asynchronously.

### 8. Eighth Embodiment

In the above-described sixth embodiment, the control SNN 653 increases or decreases the counter threshold CTH by two stages. In an eighth embodiment, a control SNN 653 increases or decreases a counter threshold CTH on the basis of the stage and the rate.

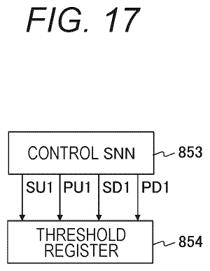

FIG. 17 is a block diagram illustrating a configuration example of a control SNN according to the eighth embodiment.

In the drawing, a control SNN 853 generates an up signal SU1 that increases the counter threshold CTH by one stage and an up signal PU1 that increases the counter threshold CTH by a constant rate. Furthermore, the control SNN 853 generates a down signal SD1 that decreases the counter threshold CTH by one stage and a down signal PD1 that decreases the counter threshold CTH by a constant rate.

A threshold register 854 stores the counter threshold CTH for a count value CNT of a pulse output from a light receiving section 121, and outputs the counter threshold CTH to a circuit section 131. The threshold register 854 can update the counter threshold CTH on the basis of the up signals SU1 and PU1 and the down signals SD1 and PD1 from the control SNN 853.

The control SNN 853 and the threshold register 854 may be applied to any of the solid-state imaging devices of the first to fourth embodiments described above.

As described above, in the above-described eighth embodiment, the control SNN 853 increases or decreases the counter threshold CTH on the basis of the stage and the rate. Therefore, it is possible to more finely update the counter threshold CTH while suppressing the enlargement of the configuration of the control SNN 853, and it is possible to control the event rate of the event IVE asynchronously.

### 9. Ninth Embodiment

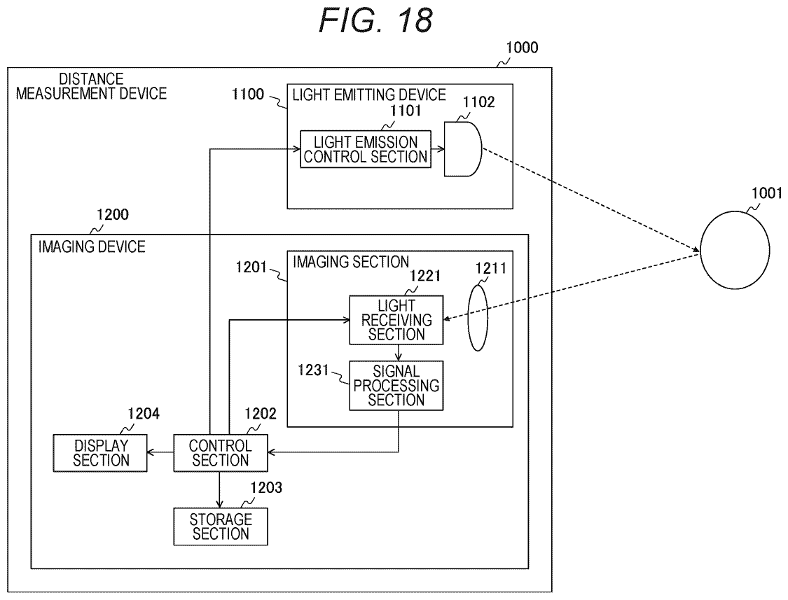

FIG. 18 is a block diagram illustrating a configuration example of a distance measurement device according to a ninth embodiment.

In the drawing, a distance measurement device 1000 captures a distance image on the basis of, for example, time of flight (ToF). The distance image can be generated from a distance pixel signal based on a distance for each pixel in a depth direction from the distance measurement device 1000 to a subject 1001.

The distance measurement device 1000 includes a light emitting device 1100 and an imaging device 1200. The light emitting device 1100 includes a light emission control section 1101 and a light emitting section 1102.

The light emission control section 1101 controls a light irradiation pattern of the light emitting section 1102 according to the control of the control section 1202. The light emitting section 1102 emits light in a predetermined wavelength region under the control of the light emission control section 1101. The predetermined wavelength range may be an infrared range. The light emitting section 1102 may be a laser diode or a light emitting diode.

The imaging device 1200 receives, for each pixel, reflected light obtained by reflecting light emitted from the light emitting device 1100 by the subject 1001, and generates a distance image. The imaging device 1200 includes an imaging section 1201, a control section 1202, a storage section 1203, and a display section 1204. The imaging section 1201 includes an optical system 1211, a light receiving section 1221, and a signal processing section 1231.

The optical system 1211 forms an image of the incident light on a light receiving surface of the light receiving section 1221. Note that the optical system 1211 may include a lens, an optical filter, a diaphragm, and the like.

The light receiving section 1221 receives the reflected light reflected by the subject 1001. The light receiving section 1221 may be a SPAD or a photodiode. Under the control of the control section 1202, the light receiving section 1221 receives reflected light from the subject 1001, and supplies a pixel signal obtained as a result to the signal processing section 1231. This pixel signal represents a digital count value obtained by counting a time from when the light emitting device 1100 emits irradiation light to when the light receiving section 1221 receives the irradiation light. A light emission timing signal indicating the timing at which the light emitting section 1102 emits light is also supplied from the control section 1202 to the light receiving section 1221. The imaging section 1201 may include any of the solid-state imaging devices of the first to fourth embodiments described above.

The signal processing section 1231 processes the pixel signal supplied from the light receiving section 1221 under the control of the control section 1202. For example, the signal processing section 1231 detects a distance to the subject for each pixel on the basis of the pixel signal supplied from the light receiving section 1221, and generates a distance image indicating the distance to the subject for each pixel. For example, the signal processing section 1231 acquires the time from when the light emitting section 1102 emits light to when each pixel of the light receiving section 1221 receives light a plurality of times for each pixel. The signal processing section 1231 creates a histogram corresponding to the acquired time. Then, by detecting a peak of the histogram, the signal processing section 1231 determines the time until the light emitted from the light emitting section 1102 is reflected by the subject 1001 and returns. Moreover, the signal processing section 1231 performs calculation to obtain the distance to the object on the basis of the determined time and light speed. The signal processing section 1231 supplies the generated distance image to the control section 1202.

The control section 1202 controls the light emission control section 1101 and the light receiving section 1221. For example, the control section 1202 supplies an irradiation signal to the light emission control section 1101 and supplies a light emission timing signal to the light receiving section 1221. The light emitting section 1102 emits irradiation light according to the irradiation signal. The light emission timing signal may be the irradiation signal supplied to the light emission control section 1101. Furthermore, the control section 1202 supplies the distance image acquired from the imaging section 1201 to the display section 1204 and causes the display section 1204 to display the distance image. Moreover, the control section 1202 stores the distance image acquired from the imaging section 1201 in the storage section 1203. The control section 1202 may include a processor such as a central processing unit (CPU) or a graphics processing unit (GPU). Furthermore, the control section 1202 may include a hardware circuit such as an application specific integrated circuit (ASIC) or a field programmable gate array (FPGA).

The display section 1204 displays the distance image, a user interface screen, and the like. The display section 1204 may be a liquid crystal display device or an organic EL display device. The storage section 1203 stores the distance image, setting information used for the distance measurement, and the like. The storage section 1203 may include a semiconductor memory such as a static random access memory (SRAM) or a dynamic random access memory (DRAM), or may include a storage device such as a hard disk device or a solid state drive (SSD).

As described above, in the above-described ninth embodiment, the imaging section 1201 generates the pixel signal on the basis of an event in which an output rate of a pulse output from the light receiving section 1221 is compressed. Therefore, it is possible to suppress saturation of the event output and lack of the event output while suppressing a decrease in sensitivity, and it is possible to suppress a decrease in distance measurement accuracy due to a change in the surrounding environment.

### 10. Application Example to Mobile Body

The technology (the present technology) according to the present disclosure can be applied to various products. For example, the technology according to an embodiment of the present disclosure may also be implemented as a device mounted on any type of mobile body such as an automobile, an electric automobile, a hybrid electric automobile, a motorcycle, a bicycle, a personal mobility, an airplane, a drone, a ship, and a robot.

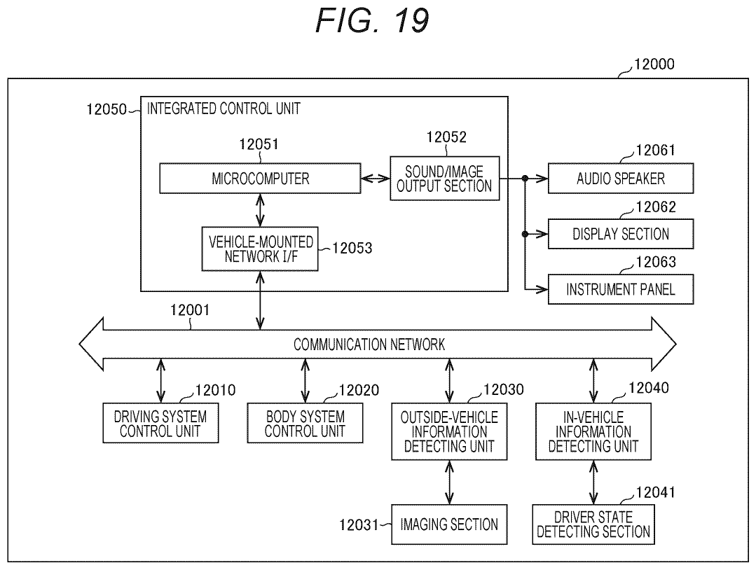

FIG. 19 is a block diagram illustrating a schematic configuration example of a vehicle control system which is an example of a moving body control system to which the technology according to the present disclosure can be applied.

The vehicle control system 12000 includes a plurality of electronic control units connected to each other via a communication network 12001. In the example illustrated in FIG. 19, the vehicle control system 12000 includes a driving system control unit 12010, a body system control unit 12020, an outside-vehicle information detecting unit 12030, an in-vehicle information detecting unit 12040, and an integrated control unit 12050. Furthermore, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. Furthermore, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

Furthermore, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 19, an audio speaker 12061, a display section 12062, and an instrument panel 12063 are illustrated as the output device. The display section 12062 may, for example, include at least one of an on-board display and a head-up display.

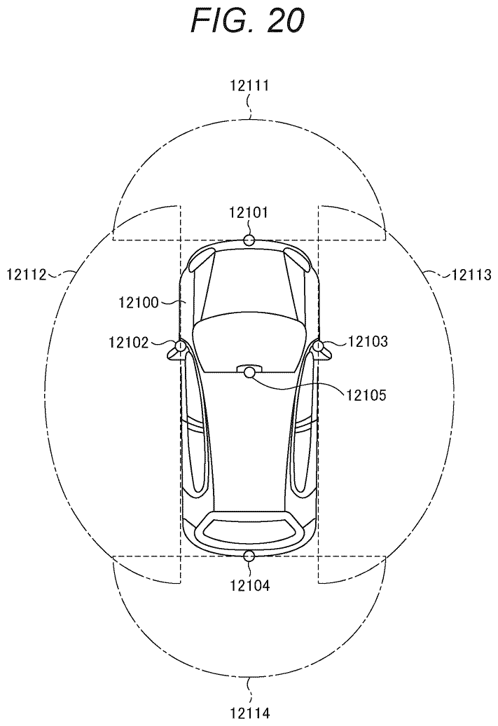

FIG. 20 is a diagram illustrating an example of the installation position of the imaging section 12031.

In FIG. 20, the imaging section 12031 includes imaging sections 12101, 12102, 12103, 12104, and 12105.

The imaging sections 12101, 12102, 12103, 12104, 12105 are provided, for example, at positions such as a front nose, a sideview mirror, a rear bumper, a back door, and an upper portion of a windshield in the interior of a vehicle 12100. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 20 illustrates an example of imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology of the present disclosure can be applied to the imaging section 12031 among the configurations described above. Specifically, for example, the above-described solid-state imaging device can be applied to the imaging section 12031. By applying the technology according to the present disclosure to the vehicle control system 12000, it is possible to suppress saturation of an imaging output and lack of the imaging output while suppressing a decrease in sensitivity of the imaging section 12031.

Note that the embodiments described above show examples for embodying the present technology, and the matters in the embodiments and the matters specifying the invention in the claims have correspondence relationships. Similarly, the matters specifying the invention in the claims and matters with the same names in the embodiments of the present technology have correspondence relationships. However, the present technology is not limited to the embodiments, and can be embodied by applying various modifications to the embodiments without departing from the gist of the present technology. Furthermore, effects described in the present specification are merely examples and are not limited, and other effects may be provided.

Note that the present technology may also have the following configurations.
(1) An imaging device including:
a light receiving section that is provided in pixels arranged in a matrix in a row direction and a column direction and outputs a pulse on the basis of incidence of photons;
a counter that is provided in the pixels and counts the pulse output from the light receiving section; and
a comparator that is provided in the pixels and outputs an event on the basis of a comparison result between a count value by the counter and a counter threshold.
(2) The imaging device according to (1) described above, in which the comparator outputs the event when the count value exceeds the counter threshold.
(3) The imaging device according to (1) or (2) described above, in which
the comparator resets the counter when the count value exceeds the counter threshold.
(4) The imaging device according to any one of (1) to (3) described above, in which
the counter and the comparator are disposed below the light receiving section.
(5) The imaging device according to any one of (1) to (4) described above, in which
the light receiving section includes a single photon avalanche diode (SPAD).
(6) The imaging device according to any one of (1) to (5) described above, further including
a control section that controls the counter threshold on the basis of an output rate of the event.
(7) The imaging device according to (6) described above, in which
the control section includes a spiking neural network that controls the counter threshold on the basis of an input of the event.
(8) The imaging device according to (7) described above, in which
the spiking neural network includes:
a plurality of first spiking neurons, each receiving an input of the event and firing on the basis of an input rate of the event; and
a second spiking neuron to which firing of the plurality of first spiking neurons is respectively input and that fires on the basis of an input rate of firing of the first spiking neurons.
(9) The imaging device according to (7) or (8) described above, in which
the spiking neural network

can detect an input rate in a spatial direction of the event and an input rate in a time direction of the event.
(10) The imaging device according to (8) described above, in which
each of the first spiking neurons includes:
a high-rate detection first spiking neuron that fires on the basis of an increase in an input rate of the event; and
a low-rate detection first spiking neuron that fires on the basis of a decrease in an input rate of the event,
the second spiking neuron includes:
a high-rate detection second spiking neuron connected such that a neuron membrane potential rises on the basis of an input of firing from the high-rate detection first spiking neuron and a neuron membrane potential falls on the basis of an input of firing from the low-rate detection first spiking neuron; and
a low-rate detection second spiking neuron connected such that a neuron membrane potential falls on the basis of an input of firing from the high-rate detection first spiking neuron and a neuron membrane potential rises on the basis of an input of firing from the low-rate detection first spiking neuron, and
the second spiking neuron includes:
a first rate detection spiking neuron connected to the first spiking neuron so that a neuron membrane potential rises on the basis of an input of the event; and
a second rate detection spiking neuron connected to the first spiking neuron so that a neuron membrane potential falls on the basis of an input of the event.
(11) The imaging device according to any one of (7) to (10) described above, in which
the spiking neural network can control the counter threshold over a plurality of stages.
(12) The imaging device according to any one of (7) to (11) described above, in which
the spiking neural network can control the counter threshold at a constant rate.
(13) The imaging device according to any one of (6) to (12) described above, in which
the control section controls a negative power supply voltage of the light receiving section on the basis of an output rate of the event.
(14) The imaging device according to any one of (1) to (13) described above, further including
a vertical arbiter that arbitrates an output of the event in the row on the basis of a detection result of the event for each row.
(15) The imaging device according to any one of (1) to (14) described above, further including
a horizontal arbiter that arbitrates an output of the event in the column on the basis of a detection result of the event for each column.
(16) A control device including
a control section that receives, as an input of an event, a comparison result between a count value of a pulse output on the basis of incidence of a photon and a counter threshold, and controls the counter threshold on the basis of an output rate of the event.
(17) The control device according to (16) described above, in which
the control section includes a spiking neural network that controls the counter threshold on the basis of the input of the event.
(18) A spiking neural network including:
a plurality of first spiking neurons, each receiving an input of a pulse generated on the basis of incidence of photons at spatial positions different from each other, and firing on the basis of an input rate of the pulse; and
a second spiking neuron to which firing of the plurality of first spiking neurons is respectively input and that fires on the basis of an input rate of firing of the first spiking neurons.
(19) The spiking neural network according to (18) described above, in which
an input rate in a spatial direction of the pulse and an input rate in a time direction of the pulse can be detected.
(20) The spiking neural network according to (18) or (19) described above, in which
each of the first spiking neurons includes:
a high-rate detection first spiking neuron that fires on the basis of an increase in an input rate of the pulse; and
a low-rate detection first spiking neuron that fires on the basis of a decrease in an input rate of the pulse, and
the second spiking neuron includes:
a high-rate detection second spiking neuron connected such that a neuron membrane potential rises on the basis of an input of firing from the high-rate detection first spiking neuron and a neuron membrane potential falls on the basis of an input of firing from the low-rate detection first spiking neuron; and
a low-rate detection second spiking neuron connected such that a neuron membrane potential falls on the basis of an input of firing from the high-rate detection first spiking neuron and a neuron membrane potential rises on the basis of an input of firing from the low-rate detection first spiking neuron.

### REFERENCE SIGNS LIST

100 Imaging device
101 Optical system
102 Solid-state imaging device
103 Imaging control section
104 Image processing section
105 Storage section
106 Display section
107 Operation section
108 Bus
110 Pixel
111 Pixel array section
112 Control section
113 Signal processing section
120 Light receiving array section
121 Light receiving section
130 Circuit array section
131 Circuit section
141 Signal line
142 Control line
151 Line scanner
152 Main processor
153 Control SNN
154 Threshold register
122 SPAD
132 Quench resistor
133 P-channel transistor
134 N-channel transistor
135 Inverter
136 Counter
137 Comparator
138 Latch circuit
129 Upper layer chip
139 Lower layer chip
229, 239 Pad electrode

1. An imaging device comprising:
a light receiving section that is provided in pixels arranged in a matrix in a row direction and a column direction and outputs a pulse on a basis of incidence of photons;
a counter that is provided in the pixels and counts the pulse output from the light receiving section; and
a comparator that is provided in the pixels and outputs an event on a basis of a comparison result between a count value by the counter and a counter threshold.

2. The imaging device according to claim 1, wherein the comparator outputs the event when the count value exceeds the counter threshold.

3. The imaging device according to claim 1, wherein
the comparator resets the counter when the count value exceeds the counter threshold.

4. The imaging device according to claim 1, wherein
the counter and the comparator are disposed below the light receiving section.

5. The imaging device according to claim 1, wherein
the light receiving section includes a single photon avalanche diode (SPAD).

6. The imaging device according to claim 1, further comprising
a control section that controls the counter threshold on a basis of an output rate of the event.

7. The imaging device according to claim 6, wherein
the control section includes a spiking neural network that controls the counter threshold on a basis of an input of the event.

8. The imaging device according to claim 7, wherein
the spiking neural network includes:
a plurality of first spiking neurons, each receiving an input of the event and firing on a basis of an input rate of the event; and
a second spiking neuron to which firing of the plurality of first spiking neurons is respectively input and that fires on a basis of an input rate of firing of the first spiking neurons.

9. The imaging device according to claim 7, wherein
the spiking neural network can detect an input rate in a spatial direction of the event and an input rate in a time direction of the event.

10. The imaging device according to claim 8, wherein
each of the first spiking neurons includes:
a high-rate detection first spiking neuron that fires on a basis of an increase in an input rate of the event; and
a low-rate detection first spiking neuron that fires on a basis of a decrease in an input rate of the event, and
the second spiking neuron includes:
a high-rate detection second spiking neuron connected such that a neuron membrane potential rises on a basis of an input of firing from the high-rate detection first spiking neuron and a neuron membrane potential falls on a basis of an input of firing from the low-rate detection first spiking neuron; and
a low-rate detection second spiking neuron connected such that a neuron membrane potential falls on a basis of an input of firing from the high-rate detection first spiking neuron and a neuron membrane potential rises on a basis of an input of firing from the low-rate detection first spiking neuron.

11. The imaging device according to claim 7, wherein
the spiking neural network can control the counter threshold over a plurality of stages.

12. The imaging device according to claim 7, wherein
the spiking neural network can control the counter threshold at a constant rate.

13. The imaging device according to claim 6, wherein
the control section controls a negative power supply voltage of the light receiving section on a basis of an output rate of the event.

14. The imaging device according to claim 1, further comprising
a vertical arbiter that arbitrates an output of the event in the row on a basis of a detection result of the event for each row.

15. The imaging device according to claim 1, further comprising
a horizontal arbiter that arbitrates an output of the event in the column on a basis of a detection result of the event for each column.

16. A control device comprising
a control section that receives, as an input of an event, a comparison result between a count value of a pulse output on a basis of incidence of a photon and a counter threshold, and controls the counter threshold on a basis of an output rate of the event.

17. The control device according to claim 16, wherein
the control section includes a spiking neural network that controls the counter threshold on a basis of the input of the event.

18. A spiking neural network comprising:
a plurality of first spiking neurons, each receiving an input of a pulse generated on a basis of incidence of photons at spatial positions different from each other, and firing on a basis of an input rate of the pulse; and
a second spiking neuron to which firing of the plurality of first spiking neurons is respectively input and that fires on a basis of an input rate of firing of the first spiking neurons.

19. The spiking neural network according to claim 18, wherein
an input rate in a spatial direction of the pulse and an input rate in a time direction of the pulse can be detected.

20. The spiking neural network according to claim 18, wherein
each of the first spiking neurons includes:
a high-rate detection first spiking neuron that fires on a basis of an increase in an input rate of the pulse; and
a low-rate detection first spiking neuron that fires on a basis of a decrease in an input rate of the pulse, and
the second spiking neuron includes:
a high-rate detection second spiking neuron connected such that a neuron membrane potential rises on a basis of an input of firing from the high-rate detection first spiking neuron and a neuron membrane potential falls on a basis of an input of firing from the low-rate detection first spiking neuron; and
a low-rate detection second spiking neuron connected such that a neuron membrane potential falls on a basis of an input of firing from the high-rate detection first spiking neuron and a neuron membrane potential rises on a basis of an input of firing from the low-rate detection first spiking neuron.
